(19) United States
(12) Patent Application Publication
(10) Pub. No.: US 2019/0136969 A1
(43) Pub. Date: May 9, 2019

(54) CONTROL METHOD FOR PREDICTION, DETECTION, AND COMPENSATION OF TORQUE REVERSAL DURING SYNCHRONOUS SHIFTING OF A BALL-TYPE CONTINUOUSLY VARIABLE PLANETARY

(71) Applicant: Dana Limited, Maumee, OH (US)

(72) Inventors: Jeffrey M. David, Cedar Park, TX (US); T. Neil McLemore, Georgetown, TX (US)

(21) Appl. No.: 16/180,079

(22) Filed: Nov. 5, 2018

Related U.S. Application Data
(60) Provisional application No. 62/582,975, filed on Nov. 8, 2017.

(51) Int. Cl. F16H 61/02

(52) U.S. Cl. CPC F16H 61/0246; F16H 2061/6608; F16H 2061/0216; F16H 61/0213

(57) ABSTRACT

A control system for a multiple-mode continuously variable transmission is described as having a ball planetary variator operably coupled to multiple-mode gearing. The control system has a transmission control module configured to receive a plurality of electronic input signals, and to determine a mode of operation from a plurality of control ranges based at least in part on the plurality of electronic input signals. In some embodiments, the system is configured to predict, detect, and compensate for a torque reversal module through the ball planetary variator.

### RELATED APPLICATION

This application claims priority to U.S. Provisional Application 62/582,975 filed on Nov. 8, 2017 which is hereby incorporated in by reference.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that may be implemented in a CVT may not be sufficient for some applications. A transmission may implement a combination of a CVT with one or more additional CVT stages, one or more fixed ratio range splitters, or some combination thereof in order to extend the range of available ratios. The combination of a CVT with one or more additional stages further complicates the ratio control process, as the transmission may have multiple configurations that achieve the same final drive ratio.

The different transmission configurations can, for example, multiply input torque across the different transmission stages in different manners to achieve the same final drive ratio. However, some configurations provide more flexibility or better efficiency than other configurations providing the same final drive ratio.

The criteria for optimizing transmission control may be different for different applications of the same transmission. For example, the criteria for optimizing control of a transmission for fuel efficiency may differ based on the type of prime mover applying input torque to the transmission. Furthermore, for a given transmission and prime mover pair, the criteria for optimizing control of the transmission may differ depending on whether fuel efficiency or performance is being optimized.

### SUMMARY

Provided herein is a method for controlling ratio in a ball planetary variator (CVP) in a multiple mode transmission, said CVP operably coupled to an engine of a vehicle, the method including: sensing a commanded transmission mode; commanding a release of an off-going clutch based on the commanded transmission mode; commanding an engagement of an on-coming clutch based on the commanded transmission mode; calculating a torque capacity of the on-coming clutch; calculating a torque capacity of the off-going clutch; comparing the torque capacity of the on-coming clutch and the torque capacity of the off-going clutch; and commanding a CVP position correction when the torque capacity of the on-coming clutch is greater than the torque capacity of the off-going clutch.

Provided herein is a method for controlling ratio in a ball planetary variator (CVP) in a multiple mode transmission, said CVP operably coupled to an engine of a vehicle, the method including: sensing a commanded transmission mode; commanding a release of an off-going clutch based on the commanded transmission mode; commanding an engagement of an on-coming clutch based on the commanded transmission mode; determining an anticipated time to engagement of the on-coming clutch; and commanding a CVP position correction at a predetermined time based on the anticipated time to engagement of the off-coming clutch.

Provided herein is a method for controlling ratio in a ball planetary variator (CVP) in a multiple mode transmission, said CVP operably coupled to an engine of a vehicle, the method including: sensing an early commanded transmission mode, an on-going clutch speed, and an off-going clutch speed; commanding a release of an off-going clutch based on the early commanded transmission mode; commanding an engagement of an on-coming clutch based on the early commanded transmission mode; detecting a slip speed of the on-coming clutch; and commanding a CVP position correction based on the detection of a speed change in the on-coming clutch and the off-going clutch.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the ball-type variator of FIG. 1.

FIG. 3 is an illustrative view of different tilt positions of the ball-type variator of FIG. 1.

FIG. 4 is a schematic diagram of a representative multiple-mode transmission having a continuously variable planetary and a range box.

FIG. 5 is a chart depicting variator speed ratio versus transmission speed ratio under ideal operating conditions of the transmission of FIG. 4.

FIG. 6 is a chart depicting variator speed ratio versus transmission speed ratio under actual operating conditions of the transmission of FIG. 4.

FIG. 7 is a chart depicting variator speed ratio versus transmission speed ratio for actual operating conditions when a transmission control system is implemented for operation of the transmission of FIG. 4.

FIG. 8 is a chart depicting relationships between transmission input speed, transmission output torque, variator speed ratio, and transmission speed ratio during a shift from operating mode 1 to operating mode 2 of the transmission of FIG. 4.

FIG. 9 is a block diagram depicting a control system for the transmission of FIG. 4.

FIG. 10 is a chart depicting variator speed ratio and commanded variator position versus time during a shift from operating mode 1 to operating mode 2 of the transmission of FIG. 4.

FIG. 11 is another chart depicting variator speed ratio and commanded variator position versus time during a shift from operating mode 1 to operating mode 2 of the transmission of FIG. 4.

FIG. 12 is yet another chart depicting variator speed ratio and commanded variator position versus time during a shift from operating mode 1 to operating mode 2 of the transmission of FIG. 4.

FIG. 13 is a flow chart depicting an embodiment of a control process for commanded a variator position during a shift from operating mode 1 to operating mode 2 of the transmission of FIG. 4.

FIG. 14 is a flow chart depicting another embodiment of a control process for commanded a variator position during a shift from operating mode 1 to operating mode 2 of the transmission of FIG. 4.

FIG. 15 is a flow chart depicting yet another embodiment of a control process for commanded a variator position during a shift from operating mode 1 to operating mode 2 of the transmission of FIG. 4.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller can be configured to receive input signals indicative of parameters associated with an engine coupled to the transmission. The parameters can include throttle position sensor values, vehicle speed, gear selector position, user-selectable mode configurations, and the like, or some combination thereof. The gear selector position is typically a PRNDL position. The electronic controller can also receive one or more control inputs. The electronic controller can determine an active mode and a variator ratio based on the input signals and control inputs. The electronic controller can control an overall transmission ratio of the variable ratio transmission by controlling one or more electronic actuators and/or hydraulic actuators such as solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. Patent Application No. 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

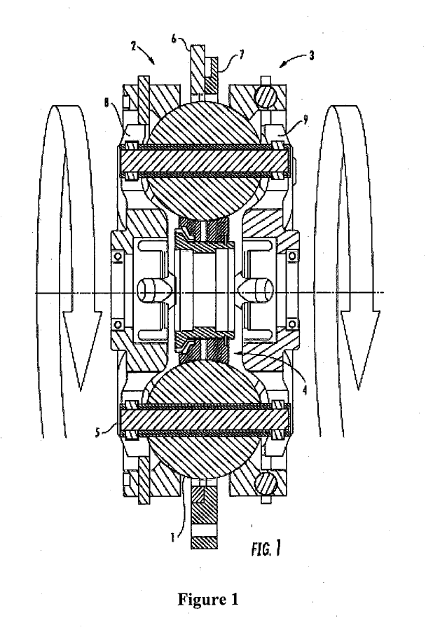

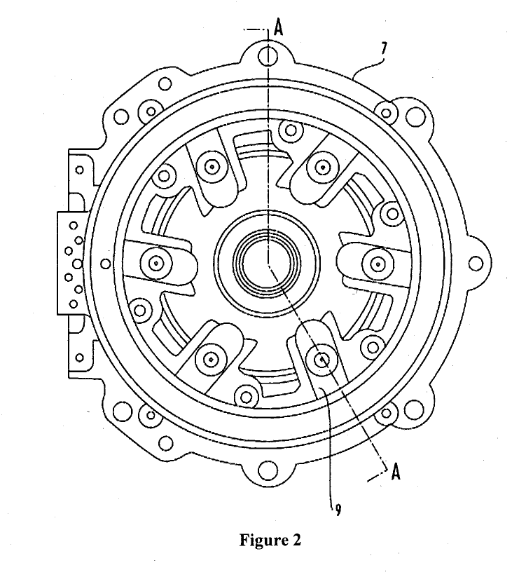

Provided herein are configurations of CVTs based on a ball type variators, sometimes referred to herein as a continuously variable planetary (“CVP”). Basic concepts of a ball type Continuously Variable Transmission are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input (first) traction ring 2, an output (second) traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

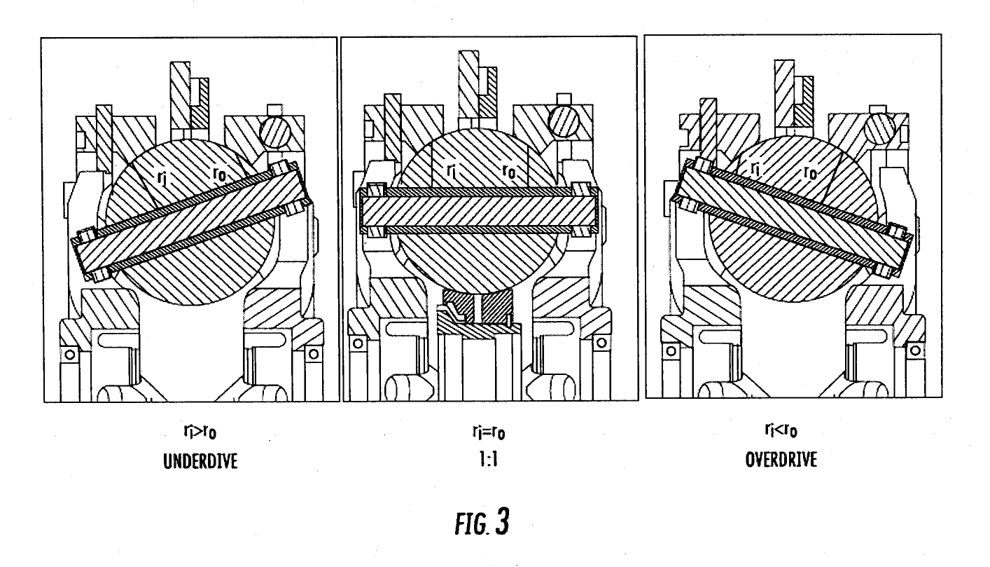

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The preferred embodiments disclosed here are related to the control of a variator and/or a CVT using generally spherical planets each having a tiltable axis of rotation that are adjusted to achieve a desired ratio of input speed to output speed during operation.

In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”.

In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source is optionally fueled by energy sources including hydrocarbon, electrical, biomass, hydraulic, pneumatic, and/or wind to name but a few. Although typically described in a vehicle or automotive application, one skilled in the art will recognize the broader applications for this technology and the use of alternative power sources for driving a transmission including this technology. For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

Those of skill will recognize that the various illustrative logical blocks, modules, circuits, strategies, schemes, and algorithm steps described in connection with the embodiments disclosed herein, including with reference to the transmission control system described herein, for example, is optionally implemented as electronic hardware, software stored on a computer readable medium and executable by a processor, or combinations of both. To clearly illustrate this interchangeability of hardware and software, various illustrative components, blocks, modules, circuits, strategies, schemes, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments.

For example, various illustrative logical blocks, modules, strategies, schemes, and circuits described in connection with the embodiments disclosed herein is optionally implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor is optionally a microprocessor, but in the alternative, the processor is optionally any conventional processor, controller, microcontroller, or state machine. A processor is also optionally implemented as a combination of computing devices, e.g., a combination of a DSP and a microprocessor, a plurality of microprocessors, one or more microprocessors in conjunction with a DSP core, or any other such configuration. Software associated with such modules optionally resides in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor is capable of reading information from, and writing information to, the storage medium. In the alternative, the storage medium is optionally integral to the processor. The processor and the storage medium optionally reside in an ASIC. For example, in one embodiment, a controller for use of control of the IVT includes a processor (not shown).

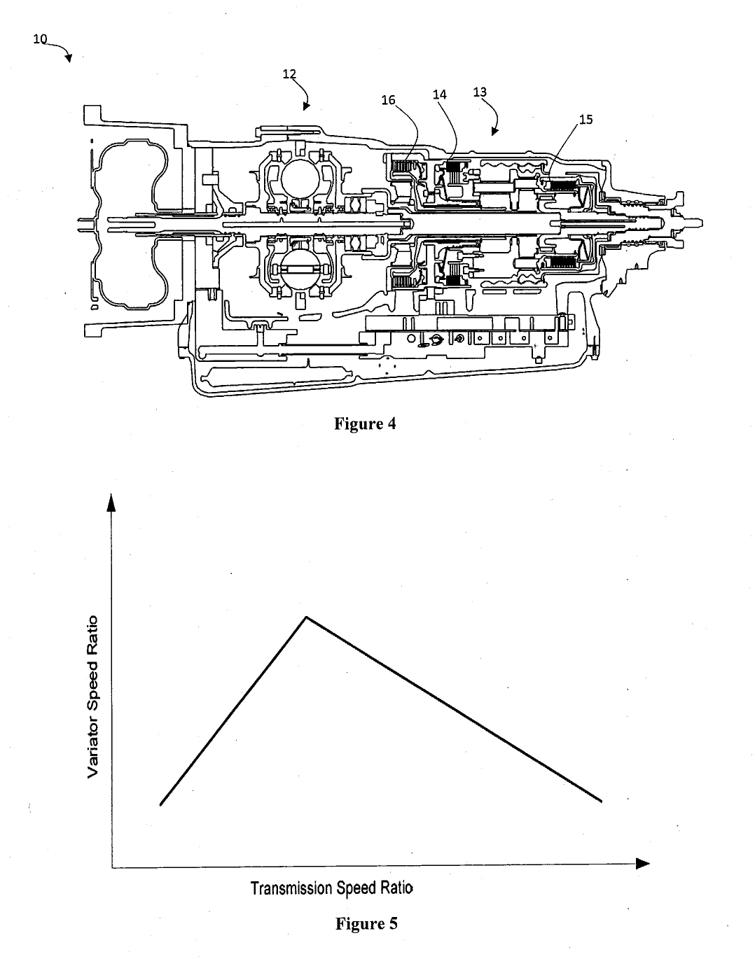

Referring now to FIG. 4, a transmission 10 is an illustrative example of a transmission having a continuously variable ratio portion, or variator 12 (“CVP”), and a multiple-mode gearing portion 13. During operation of the transmission 10, the ideal relationship between the variator speed ratio and the transmission speed ratio is depicted in the chart of FIG. 5. Under a first mode of operation, the relationship between the variator speed ratio and transmission speed ratio is depicted by a line having a positive slope. For example, the first mode of operation corresponds to the engagement of a first clutch 14. Under a second mode of operation, the relationship between the variator speed ratio and transmission speed ratio is depicted by a line having a negative slope. The second mode of operation corresponds to the disengagement of the first clutch 14 and an engagement of a second clutch 15.

In some embodiments, a reverse clutch 16 is included in the multiple-mode gearing portion 13. The reverse clutch 16 is configured to provide a reverse mode of operation.

In some embodiments, the first clutch 14, the second clutch 15, and the reverse clutch 16 are hydraulically operated clutches.

In some embodiments, the first clutch 14, the second clutch 15, and the reverse clutch 16 are mechanically operated clutches.

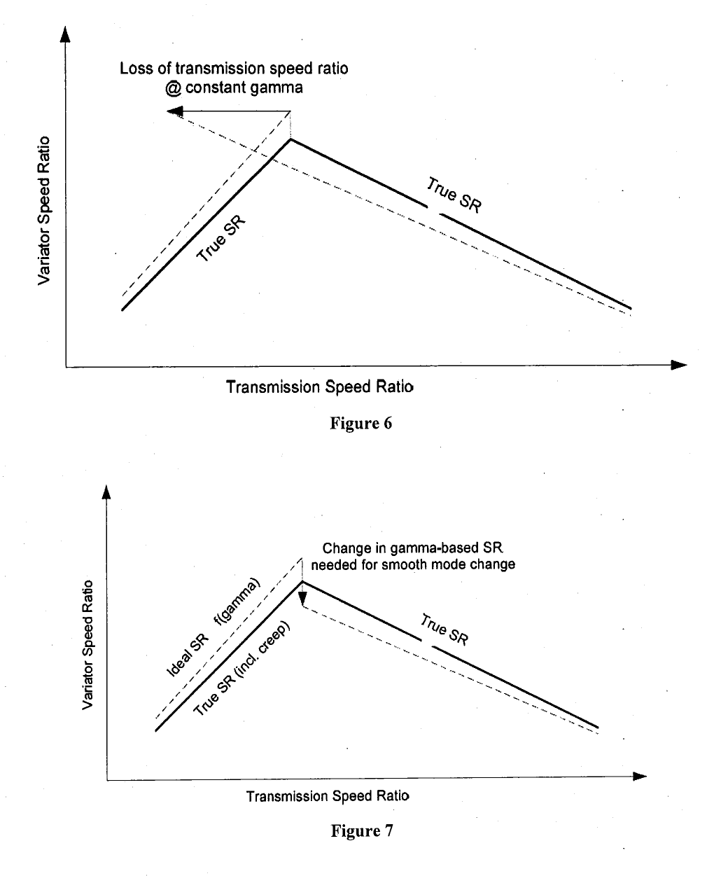

In some embodiments, the transmission shifts from the first mode to the second mode when the slip speed of the on-going (or engaging) clutch is nearly equal to zero. This type of shift event, depicted on the graph of FIG. 5 as the point of change in positive to negative slope, is referred to as the synchronous shift point. Torque transmitted through the variator portion during the transition between the first and second modes reverses direction and consequently produces a change in the actual variator speed ratio if no correction in variator position is applied. As illustrated in FIG. 6, in the absence of adjustment of the variator (CVP) portion, there is a significant loss of transmission speed ratio and an nearly instantaneous drop in output torque during the transition at the synchronous point due to creep at the traction contacts of the variator portion.

FIG. 7 illustrates the variator speed ratio versus transmission speed ratio in the presence of an active adjustment or compensation to the variator portion during the synchronous shift event.

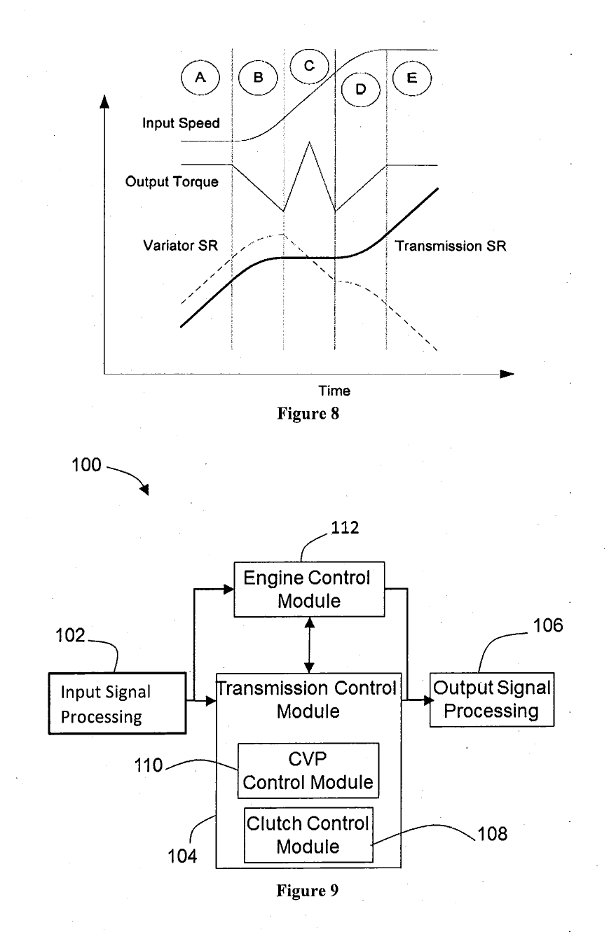

To elucidate, FIG. 8 depicts the relationship between input speed, output torque, variator speed ratio and transmission speed ratio during a synchronous shift event. During phase “C”, the first clutch 14 and the second clutch 15 are engaged, forcing a constant transmission speed ratio regardless of variator position. During this time, the variator speed ratio is changed from a value appropriate for the loads (and associated creep) of the first operating mode to a new value appropriate for a second operating mode. Previously described control systems managed the ramps into and out of the mode shift between phases “B” and “D”, by using the ratio rate of change to temporarily and smoothly reduced to zero to avoid sharp torque transitions. However, such techniques often result in unacceptable shift jerk, for example, by output torque interruption. Therefore, there is a need to predict, detect, and compensate for the torque reversal event during a shift from the first mode to the second mode and vice-versa.

Turning now to FIG. 9, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors.

In some embodiments, the output signal processing module 106 is configured to transmit commanded signals to actuators based on target values determined in the transmission control module 104.

The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission.

In some embodiments, the clutch control sub-module implements state machine control for the coordination of engagement of clutches or similar devices.

The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. In some embodiments, the vehicle control system 100 includes an engine control module 112 configured to receive signals from the input signal processing module 102 and in communication with the output signal processing module 106. The engine control module 112 is configured to communicate with the transmission control module 104.

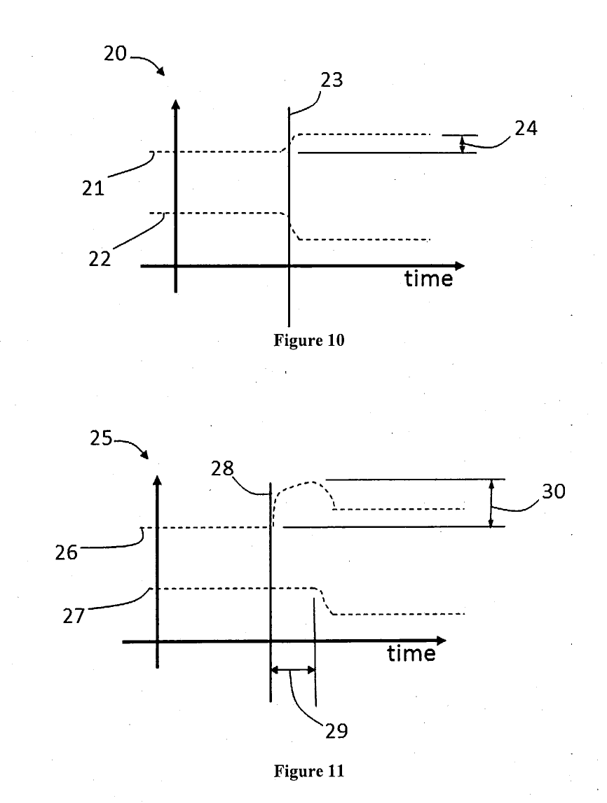

Referring now to FIGS. 10-15, entering a mode shift, the input torque to the transmission 10 is based on engine operating condition and determined through various known techniques including airflow torque models of the engine, among others. The torque at each traction ring of the CVP is calculated or modeled based on the input torque. The CVP position command corresponding to the synchronous point is requested by the control system. In anticipation of the torque reversal, a position correction command is necessary to compensate for the torque reversal during the shift. In the ideal case, a CVP position correction command is issued while the torque reversal is occurring. Due to control system lag and the speed of the torque reversal, the correction is optionally applied before the torque reversal event occurs to facilitate the actual position change coinciding exactly to the torque reversal event. Control processes to detect and predict the torque reversal and command the position correction are described herein.

Referring now to FIG. 10, a chart 20 depicts a CVP ratio 21, for example, the ratio of the variator 12, and a commanded CVP position 22 versus time. A torque reversal 23 is shown on the chart 20 with a vertical line. The chart 20 illustrates the application of a CVP position correction applied to the commanded CVP position 22 during the torque reversal 23. A CVP ratio change 24 is shown on the chart 20 and represents the difference in the CVP ratio 21 before and after the torque reversal 23. During operation of the transmission 10, when the CVP position correction is applied to the commanded CVP position 22 exactly during the torque reversal 23, the CVP ratio change 24 is a small quantity very near zero, and produces a shift that is seemingly unnoticeable to the operator of the vehicle.

Referring now to FIG. 11, a chart 25 depicts a CVP ratio 26, for example, the ratio of the variator 12, and a commanded CVP position 27 versus time. A torque reversal 28 is shown on the chart 25 with a vertical line. The chart 25 illustrates the application of a CVP position correction applied to the commanded CVP position 27 after the torque reversal 28 by a delay interval 29. A CVP ratio change 30 is shown on the chart 25 and represents the difference in the CVP ratio 26 before and after the torque reversal 28. During operation of the transmission 10, when the CVP position correction is applied to the commanded CVP position 27 after the torque reversal 28, the CVP ratio change 30 is larger than the CVP ratio change 24, and produces a shift that may be noticeable to the operator of the vehicle. As the delay interval 29 is reduced, the CVP ratio change 30 decreases.

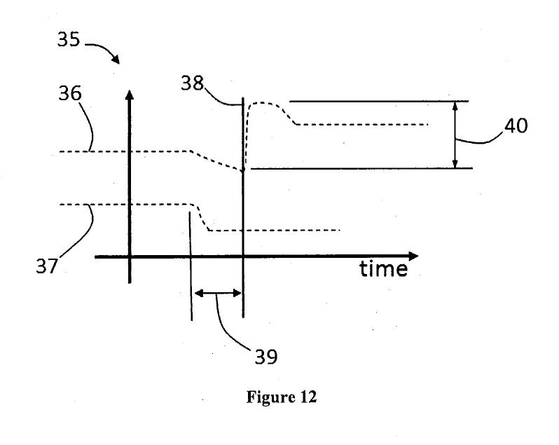

Referring now to FIG. 12, a chart 35 depicts a CVP ratio 36, for example, the ratio of the variator 12, and a commanded CVP position 37 versus time. A torque reversal 38 is shown on the chart 35 with a vertical line. The chart 35 illustrates the application of a CVP position correction applied to the commanded CVP position 37 before the torque reversal 38 by an anticipation interval 39. A CVP ratio change 40 is shown on the chart 35 and represents the difference in the CVP ratio 36 before and after the torque reversal 38. During operation of the transmission 10, when the CVP position correction is applied to the commanded CVP position 37 before the torque reversal 38, the CVP ratio change 40 is larger than the CVP ratio change 24, and produces a shift that may be noticeable to the operator of the vehicle. It should be noted that the profile of the CVP ratio 36 in time is depicted as initially decreasing and then increases. As the anticipation interval 39 is reduced, the CVP ratio change 40 decreases.

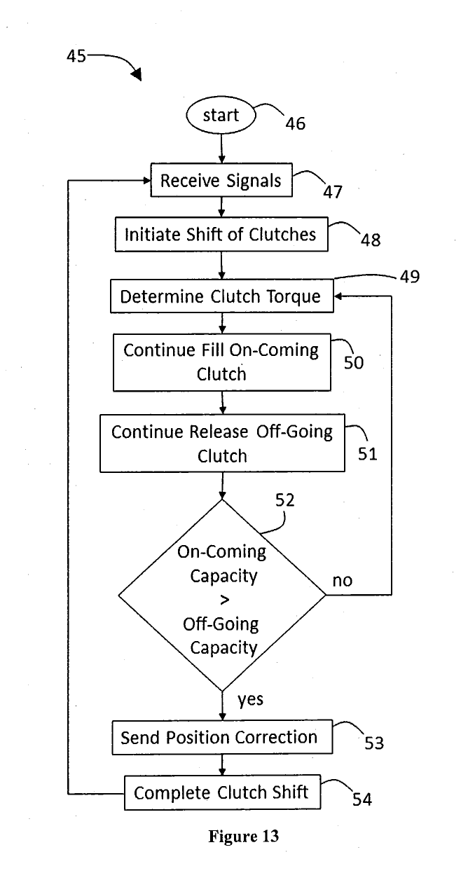

Turning now to FIG. 13, in some embodiments a control process 45 is implementable in the transmission control module 104. The control process 45 begins at a start state 46 and proceeds to a block 47 where a number of signals are received from other modules of the vehicle control system 100. For example, the signals optionally include a commanded transmission mode, an on-coming clutch pressure, an off-going clutch pressure, an on-coming clutch solenoid position, an off-going clutch solenoid position, a number of physical dimensions of the clutches, a current CVP ratio, a current transmission ratio, and an engine torque, among others. The control process 45 proceeds to a block 48 where a command is sent to initiate a shift in the clutches. For example, a shift in clutches includes release of an off-going clutch and engagement of an on-coming clutch. The control process 45 proceeds to a block 49 where a torque on the on-coming clutch and a torque on the off-going clutch are determined. It should be noted that accurate transmission input torque estimation is necessary to achieve clutch torque calculations with sufficient accuracy. The control process 45 proceeds to a block 50 where a command is sent to continue the engagement of the on-coming clutch, for example, by application of hydraulic pressure. The control process 45 proceeds to a block 51 where a command is sent to continue the release of the off-going clutch. The control process 45 proceeds to an evaluation block 52 where the torque capacity of the on-coming clutch is compared to the torque capacity of the off-going clutch. When the evaluation block 52 returns a false result, indicating that the torque capacity of the on-coming clutch is not greater than the torque capacity of the off-going clutch, the control process 45 returns to the block 47. When the evaluation block 52 returns a true result, indicating that the torque capacity of the on-coming clutch is greater than the torque capacity of the off-going clutch, the control process 45 proceeds to a block 53. The block 53 send a commanded CVP position correction.

In some embodiments, the commanded CVP position correction determined through a calibrateable look-up table based on engine torque and CVP ratio. The control process 45 proceeds to a block 54 where commands are sent to complete the clutch shift.

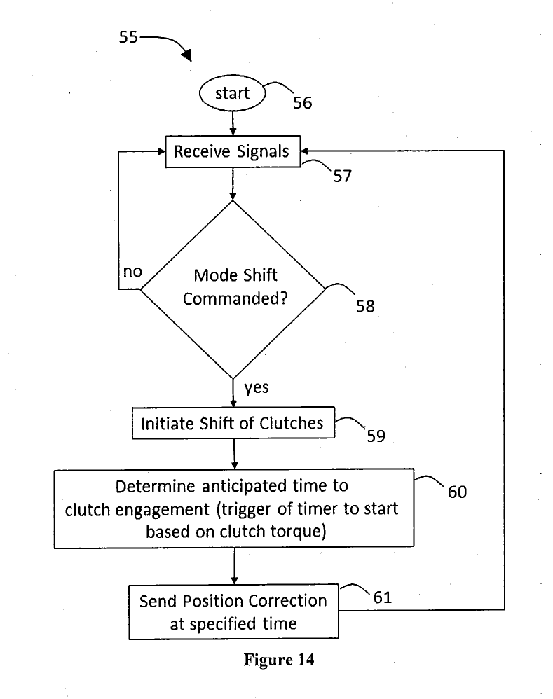

Turning now to FIG. 14, in some embodiments, a control process 55 is implementable in the transmission control module 104. The control process 55 begins at a start state 56 and proceeds to a block 57 where a number of signals are received from other modules in the vehicle control system 100.

In some embodiments, the signals optionally include a current transmission mode, a current CVP ratio, and an engine torque.

The control process 55 proceeds to an evaluation block 58. When the evaluation block 58 returns a false result, indicating that the mode shift has not been commanded by the transmission control module 104, the control process 55 returns to the block 57. When the evaluation block 58 returns a true result, indication that a mode shift has been commanded, the control process 55 proceeds to a block 59. The block 59 sends a command to initiate a shift of clutches. The control process 55 proceeds to a block 60 where an anticipated time to clutch engagement is determined.

In some embodiments, the block 60 is a trigger to start a timer based on clutch torque capacity or clutch pressure.

The control process 55 proceeds to a block 61 were a commanded CVP position correction is sent at a specified time in anticipation of the engagement of the on-coming clutch.

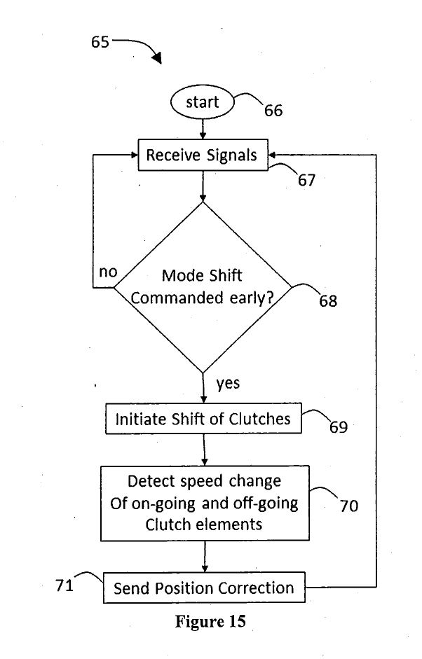

Referring now to FIG. 15, in some embodiments, a control process 65 is implementable in the transmission control module 104. The control process 65 begins at a start state 66 and proceeds to a block 67 where a number of signals are received from other modules of the vehicle control system 100.

In some embodiments, the signals optionally include a current transmission mode, a current CVP ratio, and an engine torque.

The control process 65 proceeds to an evaluation block 68. When the evaluation block 68 returns a false result, indicating that an early command for a mode shift has not occurred, the control process 65 returns to the block 67. When the evaluation block 68 returns a true result, indicating that an early command for a mode shift has been issued, the control process 65 proceeds to a block 69 where commands are sent to initiate a release of the off-going clutch and an engagement of the on-coming clutch.

In some embodiments, an early mode shift command is a command to shift the clutches at a CVP ratio that is slightly lower than the synchronous ratio. For example, a synchronous ratio of the transmission 10 is 1.78, and an early mode shift command is optionally issued at a CVP ratio of 1.73. The control process 65 proceeds to a block 70 where a slip speed across the on-going clutch element is monitored, which indicates that a torque reversal has occurred, the control process 65 proceeds to a block 71. The block 71 sends a commanded CVP position correction.

The foregoing description details the preferred embodiments. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the invention. It is intended that the following claims define the scope of the invention and that methods and structures within the scope of these claims and their equivalents be covered thereby.

What is claimed is:

1. A method for controlling ratio in a ball planetary variator (CVP) in a multiple mode transmission, said CVP operably coupled to an engine of a vehicle, the method comprising:
sensing a commanded transmission mode;
commanding a release of an off-going clutch based on the commanded transmission mode;
commanding an engagement of an on-coming clutch based on the commanded transmission mode;
calculating a torque capacity of the on-coming clutch;
calculating a torque capacity of the off-going clutch;
comparing the torque capacity of the on-coming clutch and the torque capacity of the off-going clutch; and
commanding a CVP position correction when the torque capacity of the on-coming clutch is greater than the torque capacity of the off-going clutch.

2. The method of claim 1, wherein commanding the engagement of the on-coming clutch further comprises filling the on-coming clutch with hydraulic pressure.

3. The method of claim 1, wherein calculating a torque capacity of the on-coming clutch further comprises receiving a hydraulic pressure signal of the on-coming clutch.

4. The method of claim 1, wherein calculating a torque capacity of the off-going clutch further comprises receiving a hydraulic pressure signal of the off-going clutch.

7. The method of claim 1, wherein commanding the engagement of the on-coming clutch further comprises commanding a ball screw mechanism.

6. A method for controlling ratio in a ball planetary variator (CVP) in a multiple mode transmission, said CVP operably coupled to an engine of a vehicle, the method comprising:
sensing a commanded transmission mode;
commanding a release of an off-going clutch based on the commanded transmission mode;
commanding an engagement of an on-coming clutch based on the commanded transmission mode;
determining an anticipated time to engagement of the on-coming clutch; and
commanding a CVP position correction at a predetermined time based on the anticipated time to engagement of the off-coming clutch.

7. The method of claim 6, wherein determining the anticipated time to engagement further comprises calculating a torque capacity of the on-coming clutch.

8. A method for controlling ratio in a ball planetary variator (CVP) in a multiple mode transmission, said CVP operably coupled to an engine of a vehicle, the method comprising:
sensing an early commanded transmission mode, an on-going clutch speed, and an off-going clutch speed;
commanding a release of an off-going clutch based on the early commanded transmission mode;
commanding an engagement of an on-coming clutch based on the early commanded transmission mode;
detecting a slip speed of the on-coming clutch; and
commanding a CVP position correction based on the detection of a speed change in the on-coming clutch and the off-going clutch.

9. The method of claim 8, wherein an early commanded transmission mode is a commanded transmission mode at a CVP ratio lower than a synchronous ratio.
